(19) United States
(12) Patent Application Publication
(10) Pub. No.: US 2026/0153598 A1
(43) Pub. Date: Jun. 4, 2026

(54) METHOD FOR REDUCING RADAR SIGNAL NOISE AND COMPUTER

(71) Applicant: VITESCO TECHNOLOGIES GmbH, Regensburg (DE)

(72) Inventors: Wladia WASZAK, Toulouse (FR); Emilie CUMINAL, Toulouse (FR); Damien MESSAOUDI, Toulouse (FR)

(21) Appl. No.: 18/703,985

(22) PCT Filed: Dec. 2, 2022
(86) PCT No.: PCT/EP2022/084195

§ 371 Date: Apr. 23, 2024

(30) Foreign Application Priority Data
Dec. 17, 2021 (FR) 2113756

(51) Int. Cl. G01S 7/28; G01S 7/285; G01S 13/88; G06F 3/01

(52) U.S. Cl. CPC G01S 7/2813; G01S 7/285; G01S 13/88; G06F 3/017

(57) ABSTRACT

A method for filtering noise, intended to be implemented on a set of elementary amplitude signals each coming from a sensor (2), where the sensor (2) is configured to emit emitted radiofrequency pulses (Tx(k)) and receive received elementary signals (Rx(k)) resulting from the reflection of the emitted radiofrequency pulses (Tx(k)) from a target. The method according to the invention comprises:
a. selecting a plurality of elementary amplitude signals, each associated with one of the elementary amplitude signals,
b. computing a variation indicator in relation to the selected elementary amplitude signals,
c. when the variation indicator is less than a predetermined threshold, updating a noise vector, and
d. computing a corrected elementary signal by subtracting the noise vector from the elementary amplitude signal under consideration.

### TECHNICAL FIELD

The present disclosure relates to the field of reducing noise on pulsed radiofrequency signals reflected by a target, in particular when the target is moving.

### PRIOR ART

Throughout the text, the term “radiofrequency” refers to a signal, or a pulse, the frequency of the carrier of which is between 3 kHz and 300 GHz. Preferably, the frequency of the carrier in the invention is between 5 GHZ and 20 GHZ, more preferably between 5 GHz and 10 GHz.

Pulsed radiofrequency signals are commonly used, in particular in the automotive field, to detect the presence of an object or a person in an environment. To this end, pulsed radiofrequency signals are emitted by a sensor in the direction of the environment to be studied, and then received by said sensor after the signals have been reflected in the environment. It is thus possible, for example by evaluating the time difference between the emission of the radiofrequency signal and the reception of the reflected signal, to evaluate the distance between the sensor and a target. It is also possible to detect and measure a movement of said target, in particular a movement toward and/or away from the sensor. This is then referred to as gesture detection.

Gesture detection using pulsed radiofrequency signals poses a problem because the radiofrequency signals to be analyzed comprise, in addition to the payload signal reflected by the target, parasitic signals. These parasitic signals comprise in particular reflections from the environment around the target, or else part of a radiofrequency signal emitted toward the target and traveling directly to a detection element within the sensor, without passing via the target. The parasitic signals may mask the payload signal and/or be merged therewith. The signals delivered by the sensor are thus not able to be used directly for gesture detection, and have to be cleaned of parasitic signals that interfere with the measurements. In other words, it is necessary to carry out noise filtering, where the noise corresponds to said parasitic signals.

One solution consists in using a high-pass filter to filter low-frequency signals, considering that the payload signal is associated with a fast, high-frequency movement, while the noise corresponds to slow, low-frequency variations. This solution therefore requires making a compromise between the ability to detect a slow gesture and efficient noise filtering. An excessively high cut-off frequency will thus prevent a slow gesture from being detected, while an excessively low cut-off frequency will not filter noise sufficiently.

### SUMMARY

The present disclosure aims to at least partially overcome the drawbacks of the prior art.

Another aim of the invention is to propose a solution for reducing noise due to parasitic signals without filtering at least part of a gesture that it is desired to detect.
What is proposed is a method for filtering noise, intended to be implemented on a set of elementary amplitude signals each coming from a sensor, said sensor being configured to:
   emit radiofrequency pulses, referred to as emitted pulses, in the direction of a target, and periodically with a predetermined pulse emission period, and;
   measure the amplitude of a received radiofrequency signal resulting in particular from the reflection of the emitted radiofrequency pulses from said target, the received radiofrequency signal consisting of received elementary signals each associated with a respective one of the emitted radiofrequency pulses, the amplitude of each of the received elementary signals being measured for a plurality of sampling windows and over a predetermined time range the origin of which is a time of emission of the corresponding emitted radiofrequency pulse, each sampling window being associated with an index i that refers to a difference at the origin of the corresponding time range.
Said radiofrequency pulse emission step and amplitude measurement step are implemented by said sensor, and are prior to the implementation of the method according to the invention itself.

The method according to the invention is implemented by at least one computer, the method comprising:
a. said computer receiving a plurality of elementary amplitude signals, each elementary amplitude signal being representative of the amplitude of a corresponding received elementary signal,
b. selecting a plurality of signals from among the elementary amplitude signals received in step a. so as to form a predetermined subset of elementary amplitude signals,
c. for each sampling window of index i, computing a variation indicator in relation to the elementary amplitude signals of said subset,
d. when each of a predetermined number of variation indicators is less than a predetermined threshold, updating a noise vector, said updating comprising:
   d1. computing, for each sampling window of index i, an average M(i) for said subset of elementary amplitude signals, and
   d2. constructing a new noise vector, where each component of the noise vector is associated with one of the sampling windows of index i, and where each component of the noise vector adopts a value that depends on the average M(i) computed in step d1 and associated with the same sampling window of index i, and
e. for at least one of the elementary amplitude signals, computing a corrected elementary signal by subtracting the corresponding component of the noise vector from said elementary amplitude signal and for each sampling window of index i.

According to the invention, a distinction is drawn between two cases. In a first case, the amplitude signal varies little, from one elementary signal to another, this indicating that the target is not moving. Since the target is not moving, the amplitude signal essentially corresponds to noise, and so the average amplitude values thereof are used to update the noise vector. This first case corresponds to a sufficient number of variation indicators that are each less than the predetermined threshold; preferably, all of the variation indicators are each less than the predetermined threshold. The predetermined threshold may be the same for each sampling window under consideration. As a variant, this threshold may vary depending on the sampling window under consideration.

In a second case, the amplitude signal varies greatly, from one elementary signal to another, and over at least one sampling window. It is deduced therefrom that the target is moving, meaning that the amplitude signal contains both noise and payload signal. In this case, the noise vector is not updated.

In all cases, the noise vector is then used to filter the parasitic signal.

Thus, in the method according to the invention, the filtering uses a noise vector the components of which are updated in real time. This makes it possible to adapt the filtering to changes in the external environment and the parasitic signal over time. This thus ensures that an optimum compromise between the ability to detect a slow gesture and efficient noise filtering is offered at all times. The method described above therefore makes it possible to significantly improve the signal-to-noise ratio of radiofrequency signals intended to be used to detect movements, in particular to detect gestures of a user intended to control opening of a motor-vehicle opening element.

Moreover, the method described above proposes to carry out filtering by subtracting, from the payload signal (here an elementary amplitude signal), a noise vector each component of which is associated with a predetermined sampling window. The use of a noise vector makes it possible to refine the filtering by offering a filtering threshold that depends on a difference at the time of emission of the corresponding emitted pulse. It is thus possible to take into account characteristics specific to the environment, which may be more or less noisy depending on the location under consideration (that is to say depending on the distance to the sensor, which relates to a difference at the time of emission of an emitted pulse). This makes it possible in particular to avoid a very high intensity parasitic signal, corresponding to part of the emitted signal that arrives directly on the detection zone of the sensor without having first been reflected from the target, without this affecting the payload signal.

Finally, in the prior art, filtering uses an RLC circuit filter or a digital filter. Such a filter is operational only after a predetermined time interval, called latency time, related to its time constant T. In the invention, the filtering uses subtractions from a signal instead. This thus eliminates the latency time before the filtering is operational.

In one embodiment, each of the components Gi of the noise vector is computed as follows:

$$G i = M ( i ) + C ( i )$$

where M(i) is the average associated with the sampling window of index i, for the predetermined signal subset of elementary amplitude signals; and C(i) is a positive or zero constant.

Preferably, the constant C(i) is non-zero. A constant is thus added to each component of the noise vector in order to take into account at least some of the variations of the signals in the absence of movement. This thus further improves the signal-to-noise ratio of the corrected signals.

In one embodiment, for each sampling window of index i, the variation indicator is a standard deviation STDV(i) of the subset. The standard deviation of the subset of elementary amplitude signals is thus computed over each sampling window so as to define a variation indicator specific to each sampling window.

In one particular embodiment, for each sampling window of index i, C(i) is a multiple of the standard deviation STDV(i). The variations of the signal over the sampling window under consideration are thus taken into account to determine the noise vector. This thus further improves the signal-to-noise ratio of the corrected signal.

In one embodiment, the method furthermore comprises a calibration step comprising:
receiving a plurality of elementary amplitude signals, forming elementary signals, referred to as reference elementary signals, from said sensor,
computing a reference average for each sampling window of index i and for the plurality of reference elementary signals, and
initializing, for each sampling window of index i, the component G(i) of the noise vector based on the reference average Mref(i). The initial values of the components of the noise vector are thus determined from real signals, acquired under pre-established calibration conditions, preferably in a reference environment, in the absence of a moving target.

In one embodiment, the calibration step furthermore comprises:
computing a reference standard deviation for each sampling window of index i and for the plurality of reference elementary signals, and
initializing the predetermined threshold on the basis of at least one of said reference standard deviations. The value of the predetermined threshold is thus determined from real signals acquired under pre-established calibration conditions, preferably in a reference environment in the absence of a moving target.

In one embodiment, the target comprises a hand or foot of a human operator, the method furthermore comprising a step of detecting a predetermined gesture of the human operator. What is thus also proposed is a method for detecting a predetermined gesture of the user carried out facing the sensor.

In one embodiment, the method furthermore comprises, upon detection of a predetermined gesture, a step of formulating and issuing a command to open or close a motorized motor-vehicle opening element. What is thus also proposed is a method for commanding the opening or closing of a motorized opening element in a motor vehicle. The opening element is preferably a motor-vehicle tailgate, or even a side door.

In one embodiment, the method according to the invention furthermore comprises the following steps, implemented multiple times:
f. receiving at least one elementary amplitude signal again;
g. selecting a plurality of signals from among the elementary amplitude signals received in step a. or in a previous step f., so as to form a new subset of elementary amplitude signals;
h. repeating the repetitions of steps c. to d., so as to determine a new current value of the noise vector. Preferably, step e. is implemented multiple times, each time using the current value of the noise vector. It is thus proposed to implement the noise filtering according to the invention using a sliding window of elementary amplitude signals (progressive shifting of the subset under consideration). The steps of subtracting the noise vector and of determining the current value of the noise vector may be implemented in parallel.

According to another aspect, what is proposed is an assembly of at least one computer comprising at least one memory and at least one processor, the at least one memory comprising program code instructions that, when they are executed by the at least one processor, configure said processor to implement the method according to the invention. The at least one computer comprises a computer integrated into the sensor of the method according to the invention and/or an auxiliary computer. Said auxiliary computer may be integrated on one and the same electronic card as the computer of the sensor. As a variant, said auxiliary computer may be located in a controller in communication with said sensor, for example a controller located in the passenger compartment of the vehicle. What is also proposed is a system comprising the sensor of the method according to the invention, along with said assembly of at least one computer.

The invention also covers a system comprising said sensor configured to emit the emitted radiofrequency pulses and to measure the amplitude of the received radiofrequency signal, along with the assembly of at least one computer according to the invention.

According to another aspect, what is proposed is a computer program comprising instructions for implementing all or part of a method as defined herein when this program is executed by a processor. According to another aspect, what is proposed is a non-transient computer-readable recording medium on which such a program is recorded.

### BRIEF DESCRIPTION OF THE DRAWINGS

Other features, details and advantages will emerge upon reading the following detailed description and from examining the appended drawings, in which:

FIG. 1 shows a system according to the invention for implementing a method according to the invention.

FIG. 2 shows one example of a set of elementary amplitude signals according to the invention.

FIG. 3A shows one example of an elementary amplitude signal according to the invention.

FIG. 3B shows the signal from FIG. 3A after implementation of the noise filtering method according to the invention.

FIG. 4 illustrates the noise filtering method according to one embodiment of the invention.

### DESCRIPTION OF THE EMBODIMENTS

Preferably, but without limitation, the method, the at least one computer and the system according to the invention are implemented within a motor vehicle in order to carry out gesture detection, where said gesture is carried out by a human operator located in line with the sensor and outside the vehicle. The gesture is for example a front-to-back swinging movement of the foot. Such a gesture is for example carried out by a user located at the rear of the vehicle, in line with the tailgate, with the aim of controlling opening thereof.

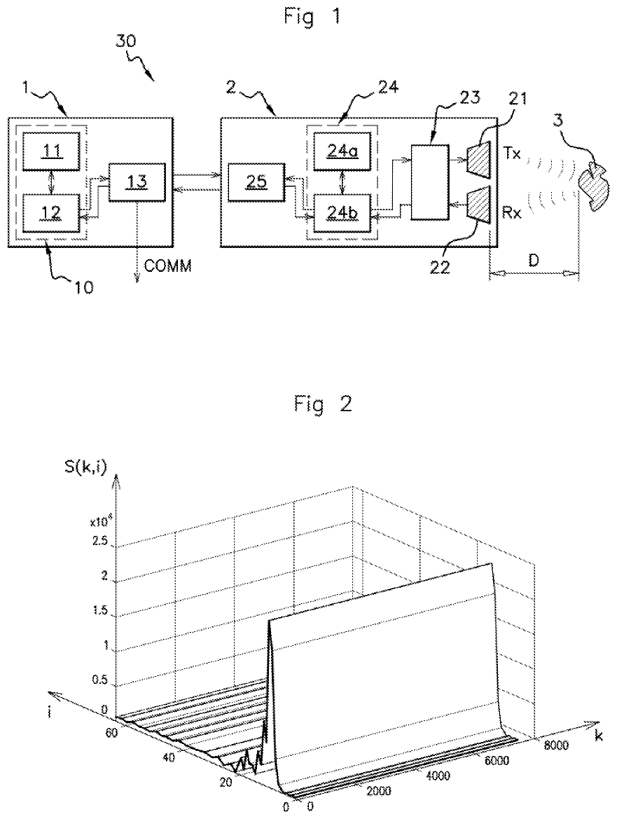

Reference is now made to FIG. 1, which illustrates a system (30) according to the invention for implementing the method of the present disclosure. According to one embodiment, the system 30 comprises a sensor 2 able to communicate with a controller 1.

The controller 1 comprises a computer 10 configured to detect a movement, for example a movement carried out by a human operator, on the basis of the signals delivered by the sensor 2. Here, but without limitation, the computer 10 is furthermore configured to issue an opening or closing command, referenced COMM, to open or close a motorized opening element, for example a vehicle tailgate or a motor-vehicle side door, upon detection of a predetermined movement. The computer 10 comprises a memory 11 and a processor 12. The memory 11 comprises program code instructions that, when they are executed by the processor 12, configure said processor to implement the movement detection and, where applicable, to issue the opening or closing command COMM.

The controller 1 furthermore comprises at least one communication interface 13 for communication with the sensor 2 and, where applicable, a control unit for controlling the motorized opening element (not shown), for example via a suitable common data transfer bus.

The sensor 2 is configured to emit emitted radiofrequency pulses Tx, periodically with a pulse emission period Te, and in the direction of a target 3. Preferably, the emitted radiofrequency pulses are modulated using the modulation technique known as “UWB”, for “ultra wideband”. This modulation technique is based on the transmission of pulses of very short duration, preferably less than one nanosecond, and over a wide frequency spectrum (for example, but without limitation, a spectral width greater than 500 MHz or even 1000 MHz). The sensor 2 is furthermore configured to measure the amplitude of a received radiofrequency signal Rx, resulting in particular from the reflection of the emitted radiofrequency pulses from the target 3. The sensor 2 thus comprises, schematically, a radiofrequency pulse emitter 21 and a radiofrequency signal receiver 22. The sensor 2 also comprises a pre-processing unit 23 for pre-processing the emitted and received radiofrequency signals, along with a computer 24 comprising a memory 24a and a processor 24b communicating with the pre-processing unit 23.

The pre-processing unit 23 may be configured to generate the emitted radiofrequency pulses Tx, which are emitted by the emitter 21, and to carry out initial processing on the received radiofrequency signal Rx. The pre-processing unit 23 may comprise in particular analog-to-digital converters. The computer 24 is preferably configured to determine the amplitude of the received radiofrequency signal, for each sampling window. The sensor 2 furthermore comprises a communication interface 25 configured to communicate with the controller 1.

In one embodiment, the sensor 2 sends, to the controller 1, data relating to the amplitude of the received radiofrequency signal Rx, in the form of an amplitude signal S(k).

The received radiofrequency signal Rx consists of received elementary signals Rx(k) each relating to a respective one of the emitted radiofrequency pulses. In other words, the received radiofrequency signal may be divided into received elementary signals Rx(k) each associated with a predetermined time range, where said time range has as its origin a time of emission of a respective one of the emitted radiofrequency pulses. Each received elementary signal Rx(k) has a corresponding respective elementary amplitude signal S(k).

Preferably, the sensor 2 periodically sends, to the controller 1, data relating to a new elementary amplitude signal S(k+1), as the emitted radiofrequency pulses T(k) are emitted and the received elementary signals R(k) are received.

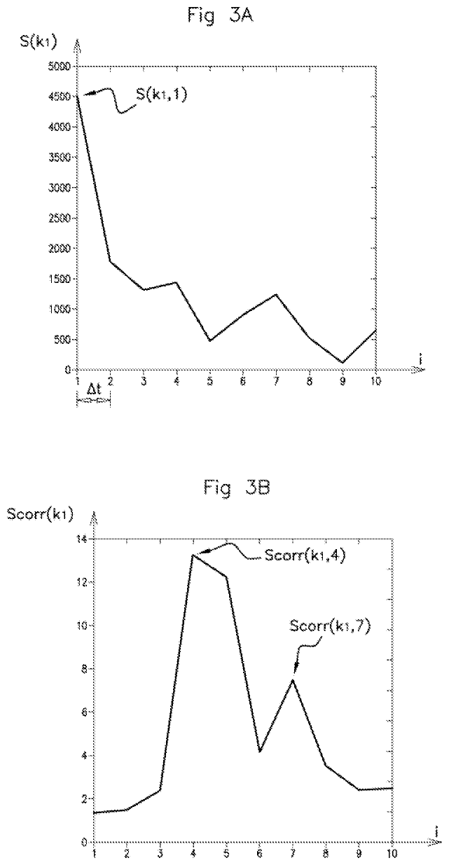

According to the invention, each of the received elementary signals R(k), and therefore each of the elementary amplitude signals S(k), is sampled temporally, with a sampling window width Δt (see FIG. 3A). Each sampling window is associated with an index i the value of which relates to a difference at the origin of the time range under consideration. The width Δt of a sampling window is between 1 ns and 6 ns. It should be noted that the index i represents an increasing delay between the emission of the pulse of index k and the reception of a signal resulting from said pulse, and that the index i is also representative of an increasing distance to the sensor of the pulse.

The elementary amplitude signals S(k) may be represented in the form of a matrix, as illustrated in FIG. 2. In the graph in FIG. 2, the axis k corresponds to an index relating to the pulse under consideration from among the emitted radiofrequency pulses, the axis i relates to the index of the sampling window under consideration, and the axis S(k,i) relates to the amplitude of the elementary amplitude signal S(k) for each sampling window i. This representation makes it possible to illustrate that the definition of the indices i of the sampling windows achieves folding of the time axis, so as to define a new time origin upon each new emission of an emitted radiofrequency pulse. Each sampling window index i thus relates to a plurality of windows, each associated with one of the elementary amplitude signals, and each associated with one and the same time difference relative to a time of emission of a corresponding pulse.

The amplitude values S(k,i) may correspond to the modulus of the received elementary signal Rx(k) received by the receiver 22 of the sensor 2. Each emitted radiofrequency pulse comprises two components, an in-phase component I and a phase-quadrature component Q, such that the modulus of the received elementary signal Rx preferably corresponds to the modulus of these components I and Q.

As may be seen in FIG. 2, each signal S(k) comprises a peak for a value of i fairly close to 0. This is a portion of the emitted radiofrequency pulse Tx that arrives directly on a detection element of the sensor 2, without having first been reflected in the environment (partial coupling of the emitted radiofrequency pulse with the receiver). It is necessary to eliminate this peak in order to access the payload signal, as illustrated by FIGS. 3A and 3B.

FIG. 3A shows a detail of an elementary amplitude signal S(k,i), with k=k₁ and i=1 to 10 as received by the controller 1 implementing the noise reduction method according to the invention. FIG. 3B shows the same detail on the corresponding corrected elementary signal Scorr(k₁, i), after implementation of the noise reduction method according to the invention. As may be seen, the peak at i=1 S(k₁, 1) present in FIG. 3A has disappeared, and so signal variations of an amplitude at least 300 times smaller have become visible. The peaks Scorr(k₁,4) and Scorr(k₁,7), now visible in FIG. 3B, correspond to reflections of the emitted radiofrequency pulse from at least one target located close to the sensor, for example less than one meter from said sensor. It may therefore be seen that the method and the computer according to the invention make it possible to efficiently filter noise, in particular making it possible to isolate a payload signal that would otherwise be masked by the high-amplitude peak mentioned above. It should also be noted that this payload signal, otherwise masked by the high-amplitude peak, corresponds to a distance to the target of less than one meter. Now, such a distance to the target corresponds to the typical distances of the target, in the context of gesture detection for controlling the opening of a motor-vehicle opening element, where the target is for example a foot or a hand of a user located outside the vehicle, close to the sensor.

It should be noted that it is not ruled out for the pre-processing unit 23 to comprise a high-pass filter for partially filtering the parasitic signals, the noise reduction method according to the invention then being implemented in addition. It is then possible to use a less efficient and therefore more reactive filter, and to supplement the noise reduction by implementing the steps of the method according to the invention. This thus makes it possible to increase the noise reduction efficiency of existing inefficient sensors.

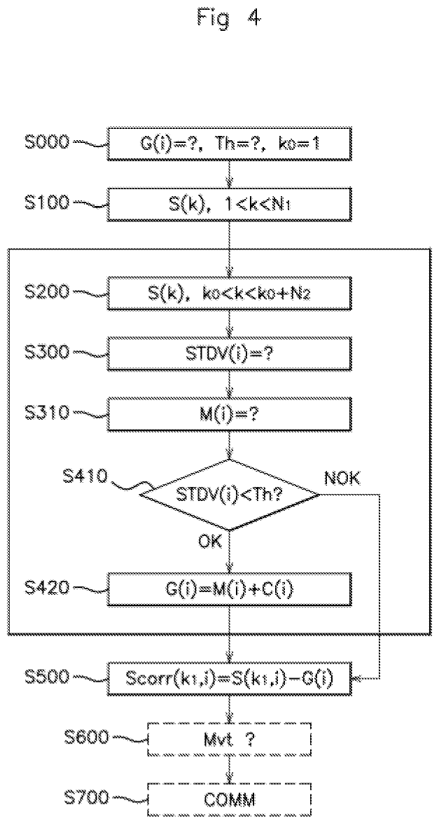

FIG. 4 illustrates various steps that may be implemented by the method according to one embodiment.

The method comprises an optional calibration step S000 for initializing various constants used in subsequent steps of the method.

Calibration step S000 may comprise:
a sub-step of receiving a plurality of elementary radiofrequency signals, referred to as reference elementary signals, Sref(k), 1<k<N₁, from the sensor 2 and relating to a series of emitted pulses TX(k), 1<k<N₁. Said plurality of signals is for example in the form of a matrix similar to that described with reference to FIG. 2,
a sub-step of computing, for each sampling window of index i and for the plurality of reference elementary radiofrequency signals Sref(k), 1<k<N₃, a reference average Mref(i), where N₃ is an integer greater than or equal to 2,
a sub-step of initializing, for each sampling window of index i, a component G(i) of a noise vector G based on the reference average Mref(i).

The calibration step S000 thus makes it possible in particular to initialize the various components G(i) of a noise vector G intended to be subtracted from an elementary amplitude signal S(k).

Step S000 may also initialize the value of a threshold Th, as mentioned below.

Step S000 may also comprise initializing a number N₂ mentioned later, and relating to a number of elementary amplitude signals together forming a subset as mentioned later.

It should be noted that the reference signals Sref(k) are preferably obtained under pre-established calibration conditions, in the absence of a moving target, for example on a production line with a predefined environment or at the start of the method (assuming that the user will wait a few moments before starting their gesture).

The method also comprises a step S100 of receiving a number N₁ of elementary amplitude signals S(k), where N₁ is an integer greater than or equal to 2. The N₁ elementary amplitude signals S(k) are for example in the form of a matrix, as described with reference to FIG. 2. This step may be implemented after the calibration step S000, or during the calibration step S000, the elementary amplitude signals received in step S100 then being able to be at least partially merged with the reference elementary signals Sref(k).

Next, the method then comprises a step S200 of selecting N₂ signals, from among the N₁ elementary amplitude signals received in step S100, so as to form a predetermined subset of elementary amplitude signals, where N₂ is an integer greater than or equal to 3, preferably greater than or equal to 10. This preferably involves selecting N₂ consecutive signals from the set of signals S(k) received in step S100. The subset is then formed by signals S(k) with k₀<k<k₀+N₂, where k₀ is a strictly positive integer defining an index of the first emitted radiofrequency pulse under consideration.

The method then comprises a step S300 of computing, for each sampling window of index i, a variation indicator in relation to the signals of the subset defined in step S200. For example, for each sampling window of index i, it is possible to compute the standard deviation STDV(i) for the subset defined in step S200.

The method also comprises a step S310 of computing, for each sampling window of index i, an average M(i) of the signals S(k). This average is computed from the values S(k, i) of the signals S(k), k₀<k<k₀+N₂ of the subset. This step is preferably carried out after step S300 so as to optimize the computing times and the memory resources required. As a variant, it may be carried out at the same time, or before step S300.

The method then comprises a step S410 in which it is determined whether or not a predetermined number of the variation indicators defined in step S300 is less than a predetermined threshold Th. When this is the case, the noise vector is updated with values taking into account the current environment facing the sensor. This check is used to ensure that the update is carried out only when the signals of the subset have a relatively low drift, so as to correspond to what are known as normal fluctuations of the environment, that is to say in the absence of a movement to be detected. In the absence of said predetermined number of variation indicators that is less than the predetermined threshold Th, the noise vector is not updated and there is a direct transition to step S500 described below.

In the example described here, it is checked, in a step S410, whether a predetermined number of standard deviations determined in step S300 is less than one and the same predetermined threshold Th, for a plurality of sampling windows. Preferably, the check is carried out for each of the sampling windows.

As a variant, it is also possible to define a predetermined threshold Th(i) specific to each sampling window. The predetermined threshold Th(i) for example depends on a standard deviation STDVref(i) computed beforehand in the calibration step S000, for each sampling window of index i and for the plurality of reference elementary signals Sref(k). The calibration step S000 then comprises an optional sub-step of initializing at least one predetermined threshold Th(i) on the basis of at least one reference standard deviation STDVref(i).

Checking whether each of a predetermined number of variation indicators is less than a predetermined threshold, where each variation indicator is specific to a respective one of the sampling windows, makes it possible to avoid incorrect detections of the absence or presence of a gesture in the event of one-off anomalies. The predetermined number of variation indicators taken into account may correspond to all of the sampling windows i or at the very least to a sufficient number of sampling windows, for example at least 10.

If a predetermined number of variation indicators is less than a predetermined threshold, a step S420 of updating the noise vector G is carried out, in which each component G(i) of the vector G is updated. Each component G(i) is updated using at least the average M(i) determined in step S310 for the same sampling window of index i.

In particular, each component Gi of the noise vector may be computed as follows for each sampling window of index i:

$$G ( i ) = M ( i ) + C ( i ) \qquad [ Math . 1 ]$$

where C(i) is a constant specific to each sampling window. This constant C(i) may for example take into account the variation indicator specific to the same sampling window of index i. In particular, C(i) may be a multiple of the sampling variation indicator specific to the same sampling window of index i. It is thus possible to have for example:

$$C ( i ) = I * STDV ( i ) \qquad [ Math . 2 ]$$

where l is a strictly positive integer.

As a variant, C(i) may adopt the value zero.

The noise vector G is thus adjusted by also taking into account the variations of the signal S(k) measured on the subset under consideration. The noise vector G thus takes into account the background noise present in the environment facing the sensor 2.

In a following step S500, the updated noise vector G is used to compute a corrected elementary signal Scorr(k₁) according to the following formula:

$$Scorr ( i , {k}_{1} ) = S ( i , {k}_{1} ) - G ( i ) \qquad [ Math . 3 ]$$

with 1<k₁<N₁,
S(i,k₁) being the value of an elementary amplitude signal, and Scorr(i,k₁) being the value of the corresponding corrected elementary signal for this same window of index i.

Thus, for each elementary amplitude signal S(k₁) under consideration, for each sampling window of index i, the component G(i) of the noise vector is subtracted from the value S(i,k₁). Step S500 thus carries out noise filtering by subtracting, from each sampling window i, a corresponding component of the noise vector G.

Elementary amplitude signals S(k) are advantageously received continuously. Thus, step S100 of receiving N₁ elementary amplitude signals is followed by other steps of receiving elementary amplitude signals S(k), implemented at the same time as steps S200 et seq.

Therefore, the elementary amplitude signal S(k₁) that is corrected in step S500 may be one of the N₁ signals received in step S100, or an elementary amplitude signal that is received subsequently during the implementation of steps S200 to S420. The index k₁ may thus relate to one of the N₂ signals of the subset selected in step S200, or to a signal with an index between k₀+N₂ and N₁, or even to a signal with an index greater than N₁.

Similarly, it should be noted that, in the embodiment described here, steps S200 to S420 for updating the noise vector G are carried out before step S500 of computing a corrected elementary signal. It should be noted that steps S500 and S200 to S420 may be carried out independently, and even in parallel, such that each elementary amplitude signal is corrected with an updated current value of the noise vector G.

Preferably, upon each new reception of at least one elementary amplitude signal S(k), a new subset of elementary amplitude signals is formed. Each new subset of elementary amplitude signals preferably consists of the same number N₂ of signals. In other words, this involves implementing a sliding window of elementary amplitude signals.

Next, steps S300 to S420 are repeated.

Subsequently, or in parallel, step S500 is also repeated, so as to compute a corrected signal on the basis of the current value of the noise vector.

Optionally, the method may also comprise a step S600 of detecting a movement, for example a predetermined gesture of a user in the direction of the sensor. For example, this may involve detecting a movement of the foot toward and then away from the sensor. To this end, a plurality of corrected elementary signals Scorr computed in step S500 are considered. A displacement of an amplitude peak, from one signal Scorr to another, is sought. For example, this involves detecting whether this amplitude peak moves toward and then away from the origin of the time range associated with the signal Scorr, from one signal Scorr to another.

Moreover, the method may also comprise an optional step S700 of commanding the opening or closing of a motorized motor-vehicle opening element upon detection of a predetermined gesture. Step S700 comprises issuing a corresponding command COMM to the control unit for controlling the motorized opening element.

In the embodiment described here, steps S100 to S700 are implemented by the processor 12 of the controller 1. In variant embodiments, steps S100 to S500 may be implemented by a processor different from at least one other processor used to implement steps S000, S600 and S700. According to another variant, steps S100 to S500 may be implemented by the processor 24b of the sensor 2, using code instructions present in the memory 24a of the computer 24. Steps S600 and S700 may then be implemented by the processor 12 of the controller 1. According to yet another variant, steps S100 to S500 may be implemented by a processor of an additional computer integrated on the electronic card also comprising the sensor 2.

In some variants, the method according to the invention furthermore comprises a step of detecting a movement carried out by an object relative to a moving motor vehicle.

1. A method for filtering noise, intended to be implemented on a set of elementary amplitude signals each coming from a sensor (2), said sensor (2) being configured to:
emit radiofrequency pulses, referred to as emitted pulses (Tx(k)), in the direction of a target (3), and periodically with a predetermined pulse emission period (Te), and;
measure the amplitude of a received radiofrequency signal (Rx) resulting in particular from the reflection of the emitted radiofrequency pulses (Tx(k)) from said target (3), the received radiofrequency signal (Rx) consisting of received elementary signals (Rx(k)) each associated with a respective one of the emitted radiofrequency pulses (Tx(k)), the amplitude of each of the received elementary signals (Rx(k)) being measured for a plurality of sampling windows (Δt) and over a predetermined time range the origin of which is a time of emission of the corresponding emitted radiofrequency pulse, each sampling window (Δt) being associated with an index i that relates to a difference at the origin of the corresponding time range;
the method being implemented by at least one computer (10), and the method comprising:
a. said computer (10) receiving (S100) a plurality of elementary amplitude signals (S(k), 1<k<N₁), each elementary amplitude signal being representative of the amplitude of a corresponding received elementary signal (Rx(k)),
b. selecting a plurality of signals from among the elementary amplitude signals (S(k)) received in step a. so as to form a predetermined subset of elementary amplitude signals (S(k), k₀<k<k₀+N₂) (S200),
c. for each sampling window of index i, computing a variation indicator in relation to the elementary amplitude signals of said subset (S300),
d. when each of a predetermined number of variation indicators is less than a predetermined threshold (Th) (S410), updating a noise vector (G), said updating comprising:
d1. computing, for each sampling window of index i, an average M(i) for said subset of elementary amplitude signals (S(k, i), k₀<k<k₀+N₂) (S310), and
d2. constructing a new noise vector (G), where each component G(i) of the noise vector (G) is associated with one of the sampling windows of index i, and where each component G(i) of the noise vector (G) adopts a value that depends on the average M(i) computed in step d1 and associated with the same sampling window of index i (S420), and
e. for at least one of the elementary amplitude signals (S(k)), computing a corrected elementary signal (Scorr(k₁)) by subtracting the corresponding component G(i) of the noise vector from said elementary amplitude signal and for each sampling window of index i (S500).

2. The method as claimed in claim 1, wherein each of the components Gi of the noise vector is computed as follows:
$$Gi = M ( i ) + C ( i )$$
where M(i) is the average associated with the sampling window of index i, for the predetermined signal subset of elementary amplitude signals (S(k, i), k₀<k<k₀+N₂); and
C(i) is a positive or zero constant.

3. The method as claimed in claim 1, wherein, for each sampling window of index i, the variation indicator is a standard deviation STDV(i) of the subset.

4. The method as claimed in claim 2, wherein, for each sampling window of index i, C(i) is a multiple of the standard deviation STDV(i).

5. The method as claimed in claim 1, wherein the method furthermore comprises a calibration step (S000) comprising:
receiving a plurality of elementary amplitude signals, forming elementary signals, referred to as reference elementary signals (Sref(k), 1<k<N₃), from said sensor,
computing a reference average (Mref(i)) for each sampling window of index i and for the plurality of reference elementary signals (Sref(k), 1<k<N₃), and
initializing, for each sampling window of index i, the component G(i) of the noise vector based on the reference average Mref(i).

6. The method as claimed in claim 5, wherein the calibration step (S000) furthermore comprises:
computing a reference standard deviation (STDVref(i)) for each sampling window of index i and for the plurality of reference elementary signals (Sref(k), 1<k<N₃), and
initializing the predetermined threshold (Th) on the basis of at least one of said reference standard deviations (STDVref(i)).

7. The method as claimed in claim 1, wherein the target comprises a hand or foot of a human operator, the method furthermore comprising a step of detecting a predetermined gesture of the human operator (S600).

8. The method as claimed in claim 1, wherein the method furthermore comprises, upon detection of a predetermined gesture, a step of formulating and issuing a command to open or close a motorized motor-vehicle opening element (S700).

9. The method as claimed in claim 1, characterized in that it furthermore comprises the following steps, implemented multiple times:
f. receiving at least one elementary amplitude signal (S(k)) again;
g. selecting a plurality of signals from among the elementary amplitude signals (S(k)) received in step a. or in a previous step f., so as to form a new subset of elementary amplitude signals;
h. repeating the repetitions of steps c. to d., so as to determine a new current value of the noise vector (G).

10. The method as claimed in claim 9, characterized in that step e. is implemented multiple times, each time using the current value of the noise vector.

11. An assembly of at least one computer (10) comprising at least one memory (11) and at least one processor (12), the at least one memory (11) comprising program code instructions that, when they are executed by the at least one processor (12), configure said processor to implement the method as claimed in claim 1.

12. A system (30) comprising said sensor (2) configured to emit the emitted radiofrequency pulses (Tx) and measure the amplitude of the received radiofrequency signal (Rx), along with the assembly of at least one computer (10) as claimed in claim 11.

13. A computer program comprising instructions for implementing the method as claimed in claim 1 when this program is executed by a processor.

14. A non-transient computer-readable recording medium on which there is recorded a program for implementing the method as claimed in claim 1 when this program is executed by a processor.
